(19) United States
(12) Patent Application Publication
(10) Pub. No.: US 2025/0297904 A1
(43) Pub. Date: Sep. 25, 2025

(54) SENSOR

(71) Applicant: TDK Corporation, Tokyo (JP)

(72) Inventors: Masanori KOBAYASHI, Tokyo (JP); Ken UNNO, Tokyo (JP); Tetsuya SASAHARA, Tokyo (JP); Tetsuo HATA, Tokyo (JP); Lucie OUEDRAOGO, Tokyo (JP)

(73) Assignee: TDK Corporation, Tokyo (JP)

(21) Appl. No.: 19/076,097

(22) Filed: Mar. 11, 2025

(30) Foreign Application Priority Data
Mar. 21, 2024 (JP) 2024-045395

(51) Int. Cl. G01L 1/22

(52) U.S. Cl. CPC G01L 1/2287

(57) ABSTRACT

A sensor, including: a metal base having a surface formed with streaks along a first direction in plan view, and a conductive layer pattern provided on an insulation film formed on the surface; wherein, on the surface, the insulation film covers a first area which exists towards a first direction in plan view with respect to a conductive layer pattern forming area formed with the conductive layer pattern, and the surface comprises an exposed area exposed from the insulation film at a position different from the first area in plan view.

### CROSS-REFERENCE TO RELATED APPLICATIONS

This application claims priority to Japanese patent application No. 2024-045395 filed on March 21, 2024 which is incorporated herein by reference in its entirety.

The present disclosure relates to a sensor to which a conductive layer pattern is provided on an insulation film formed on the metal base.

### BACKGROUND

As a sensor such as a pressure sensor, those formed with a circuit made of a conductive layer pattern on a surface of a metal base is known. As an example of the circuit, those which uses a pressure resistance effect (also known as a piezoresistive effect) to detect strain of the base (it may also be referred to as a membrane or diaphragm) based on a resistance change is known. Also, regarding a conventional sensor using a metal base, in some cases, an exposed area is formed to expose the metal base from the insulation layer in order to secure a contact position of an electrode for electric resistance welding (see Patent Document 1).

### PRIOR ART DOCUMENTS

### Patent Documents

[Patent Document 1] JP Patent Laid Open No. 2021-43016

### SUMMARY

A sensor according to the present disclosure includes:
a metal base having a surface formed with streaks along a first direction in plan view, and a conductive layer pattern provided on an insulation film formed on the surface;
wherein, on the surface, the insulation film covers a first area which exists towards a first direction in plan view with respect to a conductive layer pattern forming area formed with the conductive layer pattern, and
the surface includes an exposed area exposed from the insulation film at a position different from the first area in plan view.

### BRIEF DESCRIPTION OF DRAWINGS

FIG. 1 is a plan diagram of a sensor and a plan view of the sensor according to the first embodiment of the present disclosure.

FIG. 2 is a conceptual view of streaks formed on a surface of a base used for the sensor shown in FIG. 1.

FIG. 3 is a schematic diagram explaining the state of the streaks formed on the surface of the base shown in FIG. 2, and FIG. 3 is a schematic cross section along a second direction near the base surface.

FIG. 4 is a conceptual diagram showing a step of fixing the sensor to other member, in the case that the sensor shown in FIG. 1 is used as a pressure sensor.

FIG. 5 is a plan diagram of a sensor according to the second embodiment, and FIG. 5 is a plan view of the sensor.

FIG. 6 is a plan diagram of a sensor according to the third embodiment, and FIG. 6 is a plan view of the sensor.

FIG. 7 is a plan diagram of a sensor according to the fourth embodiment, and FIG. 7 is a plan view of the sensor.

FIG. 8 is a conceptual diagram showing each area formed on the surface of the metal base used for the sensor shown in FIG. 1.

FIG. 9 is a plan diagram of a sensor according to a reference example, and it is a plan view of the sensor.

FIGS. 10A and 10B are conceptual diagrams showing examples of a short circuit between a conductive layer pattern and the surface of the metal base which may take place in the sensor according to the reference example.

FIG. 11A to 11C are conceptual diagrams showing examples of a short circuit between a conductive layer pattern and the surface of the metal base which may take place in the sensor according to the reference example.

### DETAILED DESCRIPTION

For a conventional pressure sensor or strain sensor, a surface as the metal base is mirror polished and used. However, in order to achieve a cost reduction and an improved production efficiency, the present inventors have developed a technology which uses a metal base formed with streaks on the surface as the metal base which is used for the pressure sensor or the strain sensor. When an exposed portions exposed from the insulation film is provided on the surface of the metal base as similar to the conventional technology, and the metal base formed with the streaks on the surface is used, the present inventors have found that an insulation property between the conductive layer pattern and the surface of the metal base cannot be secured.

It is desirable to provide a sensor which can suitably secure the insulation property between the conductive layer pattern and the surface of the metal base when the metal base having the surface formed with the streaks is used.

### First Embodiment

In blow, the present disclosure is described based on the embodiments shown in the figures.

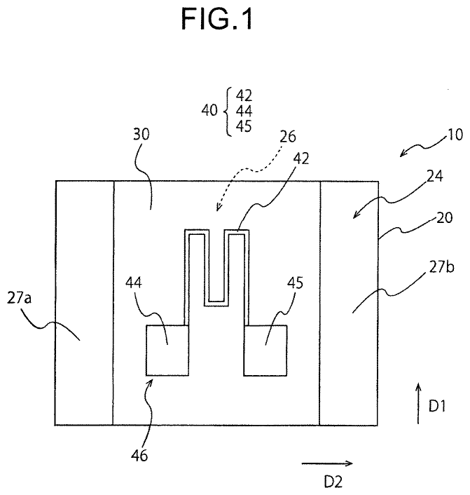

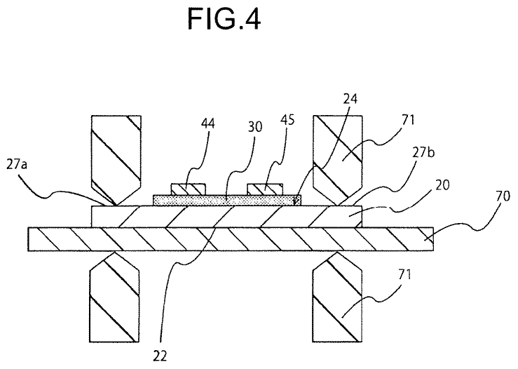

FIG. 1 is a plan diagram of a sensor 10 according to the first embodiment of the present disclosure. The sensor 10 is installed on an other member 70 shown in FIG. 4, and the sensor 10 is used as a strain sensor, etc. Note that, FIG. 4 is a cross-section view showing an example of which the sensor 10 is used as a strain sensor for measuring a strain of the other member 70.

As shown in FIG. 1 and FIG. 4, the sensor 10 includes a metal base 20, an insulation film 30, and a conductive layer pattern 40. The insulation film 30 and the conductive layer pattern 40 are stacked on a surface 24 of the metal base 20, and in the order of the insulation film 30 and the conductive layer pattern 40.

As a material of the metal base 20, for example, stainless steel, etc., may be mentioned; however, it is not limited to these as long as it is a metal material. Also, in the case that a measuring condition of the sensor 10 is under a high temperature condition, the metal base 20 may be austenitic stainless steel such as SUS 304, SUS 316, etc., or precipitation hardening stainless steel such as SUS 630, SUS 631, etc., since these materials have an excellent high temperature property.

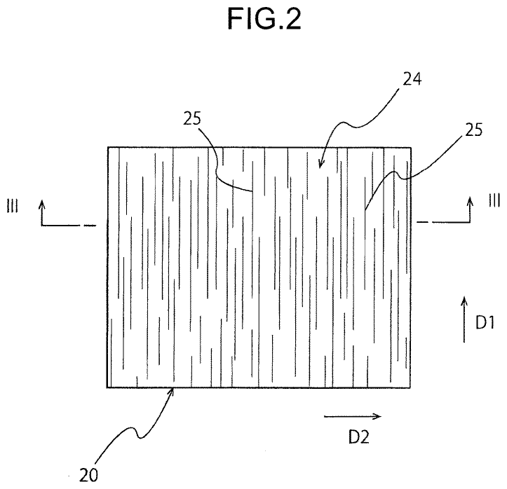

FIG. 2 is a conceptual diagram explaining the state of streaks 25 formed on the surface 24 of the metal base 20 used for the sensor 10 shown in FIG. 1. As shown in FIG. 2, the metal base 20 has the surface 24 to which the streaks are formed along a first direction D1 in plan view. As shown in FIG. 2, when the surface 24 of the metal base 20 is enlarged, the streaks 25 configured of numerous thin streaks are formed on the entire surface 24.

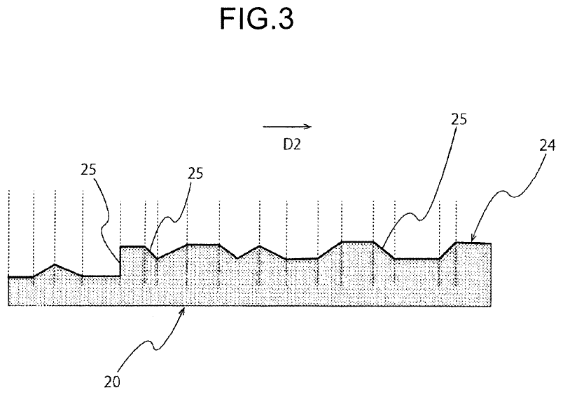

FIG. 3 is a conceptual diagram explaining the state of the streaks 25 formed on the surface 24 of the metal base 20 shown in FIG. 2, and FIG. 3 is a conceptual cross section view along a second direction D2 near the surface 24 of the meal base 20. As shown in FIG. 3, the streaks 25 are observed as ridges and grooves formed on the surface 24 on the enlarged cross section, and it may also be said that the streaks 25 are a numerous linear scarring which are parallel to the first direction D1 in plan view. Examples of ridges and grooves configuring such streaks 25 include grinding scars formed in a grinding direction during the production of the metal base 20, or rolling scars formed in a rolling direction during rolling; and these scarring are formed on the entire surface 24 in a discontinuous manner or in a continuous manner. Note that, when the streaks of different types which run in different direction in plan view are formed on the entire surface 24 (the surface of the base) discontinuously or continuously, in such case the direction of one type of the streaks with the deepest ridges and grooves is considered as the first direction D1. For example, in the case that a streak of grinding scar with the depth of the ridges and grooves of 0.1 to 1.0 μm, and a streak of polishing scar with the depth of ridges and grooves of 0.01 to 0.1 μm are formed on the surface 24, then the streak of griding scar with the depth of the ridges and grooves of 0.1 to 1.0 μm is considered as the first direction D1.

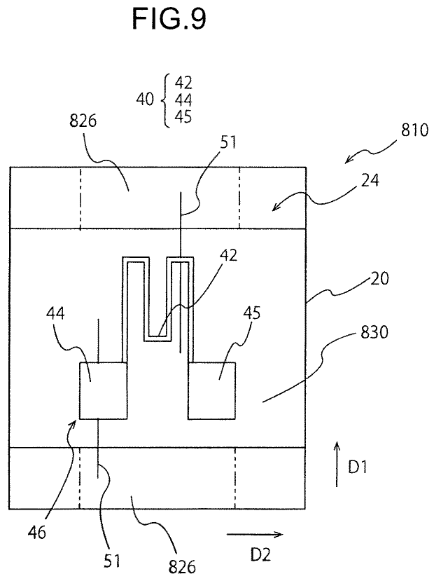

In the sensor 10, a surface roughness Ra of the surface 24 with respect to the second direction D2, which is perpendicular to the first direction D1 in plan view on the surface 24, may be between 0.05 μm or more and 1 μm or less. When the surface roughness Ra of the surface 24 is equal to or larger than the predetermined value, an etching residue 51 (see FIG. 9) of a conductive layer tends to be formed along the first direction D1; thus, this particularly enhances an effect of preventing a short circuit (a short circuit malfunction) between the conductive layer pattern 40 and the surface 24 of the metal base 20 caused by the etching residue 51. Also, when the surface roughness Ra is equal to or lower than the predetermined value, it is possible to accurately form the thin conductive layer pattern 40.

Note that, the streaks 25 formed on the surface 24 can be erased by mirror polishing the surface 24 prior to forming the insulation film 30 and the conductive layer pattern 40 on the surface 24 (see FIG. 4). However, in order to erase the streaks 25 by mirror polishing the surface 24, it requires an extra processing time and processing cost, thus lowers the productivity. On the other hand, as in the case of the metal base 20 shown in FIG. 2, by forming the insulation film 30 and the conductive layer pattern 40 on the surface 24 while the streaks 25 are formed (see FIG. 1 and FIG. 4), it is possible to improve the productivity of the sensor 10.

Also, the direction of the sensor 10 and the metal base 20 is described using a normal direction of the surface 24 which is perpendicular to the first direction D1 and the second direction D2 as a vertical direction. Further, as shown in FIG. 4, in regards with the vertical direction, a lower direction is a direction towards a rear surface 22, which is an opposite surface of the surface 24, of the metal base 20 from the surface 24 where the insulation film 30, the conductive layer pattern 40, etc., are formed; and an upper direction is a direction towards the surface 24 from the rear surface 22.

The conductive layer pattern 40 shown in FIG. 1 is provided on the insulation film 30 formed on the surface 24 of the metal base 20. For the sensor 10, the insulation film 30 is formed so as to cover parts other than exposed areas 27a and 27b formed at both ends in the second direction D2 among the surface 24 of the metal base 20. The conductive layer pattern 40 has electrode pads 44 and 45, and a resistive film 42 which connects the electrode pads 44 and 45.

A thickness of the insulation film 30 is not particularly limited, and for example, it can be 1 to 10 times of the surface roughness Ra of the surface 24 shown in FIG. 3. When the thickness of the insulation film 30 is the predetermined times or thicker with respect to the surface roughness Ra of the surface 24, an insulation property between the surface 24 of the metal base 20 and the conductive layer pattern 40 can be secured suitably. Also, when the thickness of the insulation film 30 is a predetermined times or thinner with respect to the surface roughness Ra of the surface 24, the ridges and grooves, which are traces of the streaks 25 of the surface 24, are easily formed on the surface of the conductive layer pattern 40 side of the insulation film 30; thus, the etching residue 51 of the conductive layer tends to be readily formed along the first direction D1 (see FIG. 9). Therefore, by avoiding the exposure of the surface 24 as a first direction exposed area 826 of a sensor 810 according to a reference sample shown in FIG. 9, and by forming the first area 26 and the exposed areas 27a and 27b as shown in FIG. 1, the effect and needs of preventing the short circuit caused by the etching residue 51 are particularly increased. Note that, the etching residue 51 will be described in detail using the sensor 810 according to the reference example shown in FIG. 9.

As a material of the insulation film 30 shown in FIG. 1 and FIG. 4, silicon oxide, silicon carbide, alumina, etc., may be mentioned, and as long as it is a material with an insulation property, the material of the insulation film 30 is not particularly limited. A method of forming the insulation film 30 is not particularly limited, and for example, a spattering method, a vacuum deposition method, a CVD method, a sol-gel method, etc., may be mentioned. Also, for example, the insulation film 30 can be produced using a method exhibiting a good coverage such as a TEOS-CVD method, and according to the sensor 10 of the present disclosure, a short circuit can be suitably prevented in such cases.

The conductive layer pattern 40 shown in FIG. 4 includes the electrode pads 44 and 45 and the resistive film 42. The resistive film 42 of the conductive layer pattern 40 connects the first position at the center of the electrode pad 44 and the second position at the center of the electrode pad 45 by a conductive pathway which has a shape longer than the length between the first position and the second position connected in a straight line. By forming the conductive film pattern 40 in a such shape, a long conductive pathway can be formed in a narrow area, and a detection sensitivity using the conductive layer pattern 40 can be enhanced.

The resistive film 42 of the conductive film pattern 40 has a meander shape which the conductive path has a folded shape (or a serpentine shape). Therefore, a long and narrow conductive pathway can be formed in a narrow area. Note that, as a plan shape of the resistive film 42, it is not limited to a meander shape, and it may be other shape such that the first position and the second position are connected by detouring the straight line. The same applies to the other embodiments as well.

As shown in FIG. 1, the conductive layer pattern 40 includes two electrode pads 44 and 45 and the resistive film 42 which electrically connects the two electrode pads 44 and 45. The two electrode pads 44 and 45 are connected with exterior wires, which are not shown in the figures, using a wire bonding, etc. The resistive film 42 has a square wave form or a meander form which the first direction D1 is an amplitude direction, and a conductive pathway narrower than the electrode pads 44 and 45 is formed to electrically connect the two electrode pads 44 and 45.

The conductive layer pattern 40 is a pattern made of a layer having conductivity. The conductive layer pattern 40 only needs to form a conductive pathway between the first position and the second position, and the conductive layer pattern may be configured of a single layer or a layer(s) made of the same materials, a plurality of layers, layers made of different materials, etc. The electrode pads 44 and 45 of the conductive layer pattern 40 shown in FIG. 1 and the resistive film 42 may be made of the same material, or may be made of different materials. As the material of the resistive film 42 of the conductive layer pattern 40 according to the present embodiment, metals such as Cr, Ni, Al, Cu, etc., a strain resistive film material including at least one selected from the group consisting of Cr, Ni, Al, and Cu and at least one selected from the group consisting of N and O may be mentioned; and as the material of the electrode pads 44 and 45 of the conductive layer pattern 40, good conductor metals such as Al, Au, etc., may be mentioned.

Regarding the sensor 10 shown in FIG. 1, the insulation film 30 covers an area of the surface 24 of the metal base 20 which is between a conductive layer pattern forming area 46 formed with the conductive layer pattern 40 and the first area 26 existing on the first direction D1 in plan view. In FIG. 1, the conductive layer pattern forming area 46 corresponds to the area where the resistive film 42 and the electrode pads 44 and 45 configuring the conductive layer pattern 40 are formed.

Also, regarding the sensor 10 shown in FIG. 1, the surface 24 of the metal base 20 has the exposed areas 27a and 27b which are exposed from the insulation film 30 at the position different from the first area 26 in plan view. Regarding the sensor 10 shown in FIG. 1, the surface 24 of the metal base 20 has at least two exposed areas 27a and 27b (two in the present embodiment), and the conductive layer pattern 40 in plan view is arranged between the two exposed areas 27a and 27b.

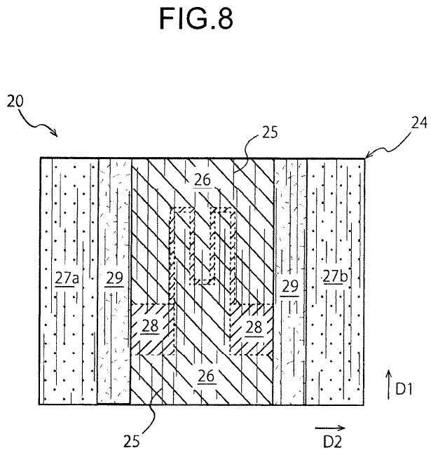

FIG. 8 is a conceptual diagram in which each area included in the sensor 10 shown in FIG. 1 are applied on the surface 24 of the metal base 20 shown in FIG. 2 and identified the areas by using different hatching, etc. As shown in FIG. 8, the surface 24 of the metal base 20 includes a conductive layer pattern under area 28, the first area 26, the exposed areas 27a and 27b, a non-exposed area 29, etc.

The conductive layer pattern under area 28 is an area directly below the conductive layer pattern 40, and it coincides with the conductive layer pattern forming area 46 shown in FIG. 1 in plan view. The first area 26 exists towards the first direction D1 in plan view with respect to the conductive pattern forming area 46 shown in FIG. 1. The conductive layer pattern under area 28 and the first area 26 are entirely covered with the insulation film 30.

The exposed areas 27a and 27b are formed at both end parts of the surface 24 in the second direction D2, and these are arranged at the positions where the positions of the exposed areas 27a and 27b in the second direction D2 do not overlap with the conductive layer pattern 40. The insulation film 30 is not formed on the exposed areas 27a and 27b, thus these are exposed from the insulation film 30.

The non-exposed area 29 is formed between the first area 26 and the exposed areas 27a and 27b. As similar to the exposed areas 27a and 27b, the non-exposed area 29 is arranged at the position where the position of the non-exposed area 29 in the second direction D2 does not overlap with the conductive layer pattern 40. Also, the position of the non-exposed area 29 in the second direction D2 does not overlap with the exposed areas 27a and 27b. The non-exposed area 29 is covered with the insulation film 30. A width of the non-exposed area 29 along the second direction D2 can be narrower than the width of the first area 26 along the second direction D2, and also can be wider than the width of the resistive film 42 (the width which is perpendicular to the conductive pathway). Forming such non-exposed area 29 between the first area 26 and the exposed areas 27a and 27b may secure the insulation property between the surface 24 of the metal base 20 and the conductive layer pattern 40.

Here, using the sensor 810 according to the reference example shown in FIG. 9, the problem in the case of using the metal base 20 having the surface 24 with the streaks 25 on is explained. FIG. 9 is a plan view of the sensor 810 according to the reference example. The sensor 810 is basically the same as the sensor 10 shown in FIG. 1 except that, in the sensor 810, the position of the area where the surface 24 of the metal base 20 is exposed from the insulation film 830 is different, and also a plan view shape of an insulation film 830 is different from that of the insulation film 30.

As shown in FIG. 9, in the sensor 810, the insulation film 830 is formed so as to cover the parts except for the both end parts in the first direction D1 of the surface 24 of the metal base 20. Thereby, in the sensor 810, the surface 24 formed with the streaks 25 has a first direction exposed area 826 which exist in the first direction D1 in plan view with respect to the conductive layer pattern forming area 46 formed with the conductive layer pattern 40, and the first direction exposed area 826 is exposed from the insulation film 830.

In the sensor 810 formed with the first direction exposed area 826 as shown in FIG. 9, due to the etching residue 51 extending along the first direction D1 in plan view, there may be a risk of causing a short circuit between the conductive layer pattern 40 and the surface 24 of the metal base 20 (the first direction exposed area 826). This is because grooves, and concavity and convexity which are traces of the streaks 25 are readily formed on the insulation film 830 on the surface 24 to which the streaks 25 are formed; hence, a thickness of a layer having conductivity formed on the insulation film 830 may also become uneven. Thus, when the conductive layer pattern 40 is formed by etching the layer having conductivity formed on the insulation film 830, and if the metal base 20 having the surface 24 to which the streaks 25 are formed is used as shown in FIG. 9, the etching residue 51 extending in the first direction D1 as similar to the streaks 25 tends to easily form on the insulation film 830.

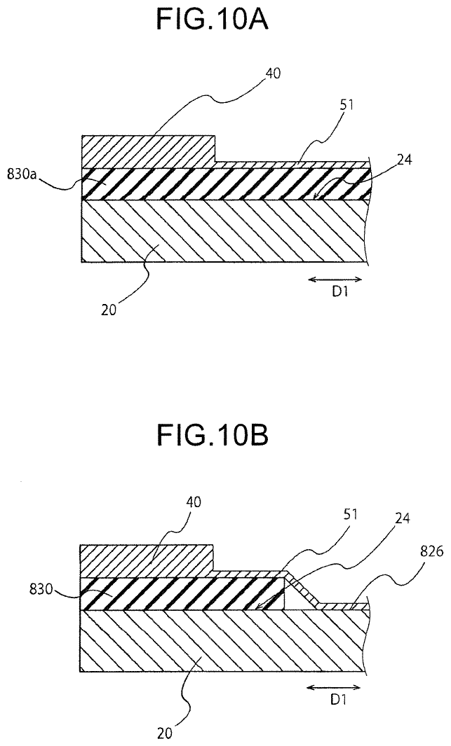

FIG. 10A and FIG. 10B are conceptual views of the production process explaining how the etching residue 51 causes short circuit in the sensor 810, and the figures are schematic cross section views of the sensor 810 in the middle of production. As shown in FIG. 10A, the insulation film 830a is formed on the surface 24 of the metal base 20; and further, the conductive layer pattern 40 is formed on the insulation film 830a. In such case, the etching residue 51 extending in the first direction D1 as same as the streaks 25 are formed. Note that, the insulation film 830a shown in FIG. 10A is formed on the entire surface 24 of the metal base 20.

After forming the conductive layer pattern 40 as shown in FIG. 10A, the insulation film 830a shown in FIG. 10A is partially removed to form the first direction exposed area 826 which the surface 24 of the metal base 20 is exposed (FIG. 10B). Thereby, as shown in FIG. 10B, the etching residue 51 which is formed when the conductive layer pattern 40 is formed connects the surface 24 of the metal base 20 and the conductive layer pattern 40, thereby a short circuit pathway is formed.

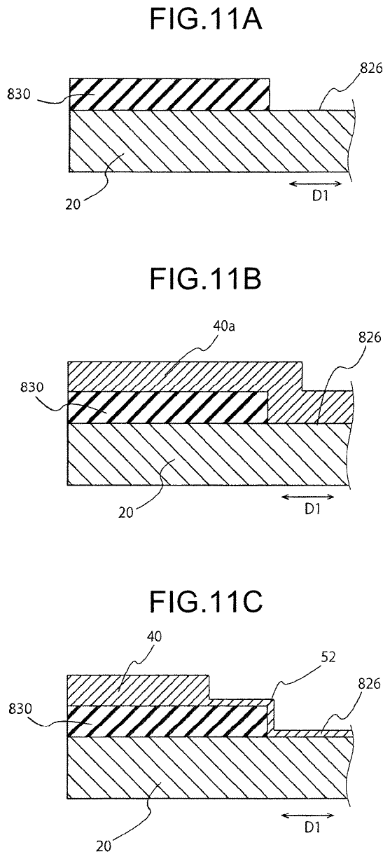

FIG. 11A to FIG. 11C are conceptual views explaining other production process in which the short circuit pathway in the sensor 810 is formed by the etching residue 52, and these figures are schematic cross section views of the sensor 810 in the middle of the production. As shown in FIG. 11A, even in the case that the first direction exposed area 826 is formed before forming the conductive film pattern 40, as shown in FIG. 11B and FIG. 11C, the surface 24 of the metal base 20 and the conductive layer pattern 40 are connected by the etching residue 52 (the etching residue formed when a layer 40a as the base of the conductive layer patter 40 is etched) extending in the first direction D1 as same as the streaks 25, thereby the short circuit pathway is formed.

Therefore, as shown in FIG. 9, the short circuit caused by the etching residue 51 tends to easily occur in the sensor 810 which is formed with the surface 24 arranged towards the first direction D1 with respect to the conductive layer pattern forming area 46 in plan view and has the first direction exposed area 826 exposed from the insulation film 830.

On the other hand, the sensor 10 shown in FIG. 1, on the surface 24, the insulation film 30 covers the first area 26 which exist towards the first direction D1 with respect to the conductive layer pattern forming area 46 in plan view. Therefore, even in the case that the etching residue 51 is formed which extends in the first direction D1 as same as the streaks 25 shown in FIG. 9, the etching residue 51 does not contact the surface 24 of the metal base 20; hence, the short circuit pathway is not formed which is different from the case shown in FIG. 9.

Also, by forming the exposed areas 27a and 27b shown in FIG. 1 on the surface 24 of the metal base 20, during a process of fixing the sensor 10 to the other member 70 as shown in FIG. 4, an electrode 71 of resistance welding contacts the exposed areas 27a and 27b; thereby, the sensor 10 can be easily welded/fixed to other members. For example, the sensor 10 detects strain of the member contacting the metal base 20 using a resistance change of the resistive film 42 of the conductive layer pattern 40.

The sensor 10 shown in FIG. 1 to FIG. 4 is, for example, produced through production steps as described in below. First, for the production of the sensor 10, the metal base 20 as shown in FIG. 2 is prepared. For example, the metal base 20 is produced by performing mechanical processing such as pressing, grinding, polishing, etc., to the predetermined metal material. Here, as shown in FIG. 2 and FIG. 3, the surface 24 is not mirror polished in order to leave the streaks 25, thereby the production steps can be simplified.

Next, layers for the insulation film 30 and the conductive layer pattern 40 are formed on the surface 24 of the metal base 20; then, fine processing is carried out using a semiconductor processing technology including etching, etc., to the formed layers. Thereby, the insulation film 30 and the conductive layer pattern 40 are formed. Due to these steps, the sensor 10 including the metal base 20 shown in FIG. 2 is obtained. Further, when the sensor 10 is used, as shown in FIG. 4, the sensor 10 including the metal base 20 is fixed to the other member 70 using resistance welding, and also the electrode pads 44 and 45 of the conductive layer pattern 40 and the exterior base, etc., which are not shown in the figures are connected using wire bonding or so. Note that, on the conductive layer pattern 40, a protective layer may be formed for protecting the conductive layer pattern 40. Also, the insulation film 30 may be formed to the metal base 20 so that the insulation film 30 has a wrapping portion which wraps around at least part of a side surface connecting to the surface 24 of the metal base 20.

By using the metal base 20 having the surface 24 formed with the streaks 25 to such sensor 10, a cost reduction and an improved production efficiency can be achieved since steps such as mirror polishing, etc., are omitted. Also, since the first area 26 is covered with the insulation film 30, even if the etching residue 51 formed along the streaks 25 of the conductive layer which forms the conductive layer pattern 40 is formed during the production steps; the insulation property between the conductive layer pattern 40 and the surface 24 of the metal base 20 can be secured appropriately. Also, the surface 24 has the exposed areas 27a and 27b at the position different from the first area 26; thus, an area for contacting the electrode of resistance welding to the surface 24 can be secured while avoiding the short circuit from occurring between the conductive layer pattern 40 and the surface 24 of the metal base 20 caused by the etching residue 51 of the conductive layer.

### Second Embodiment

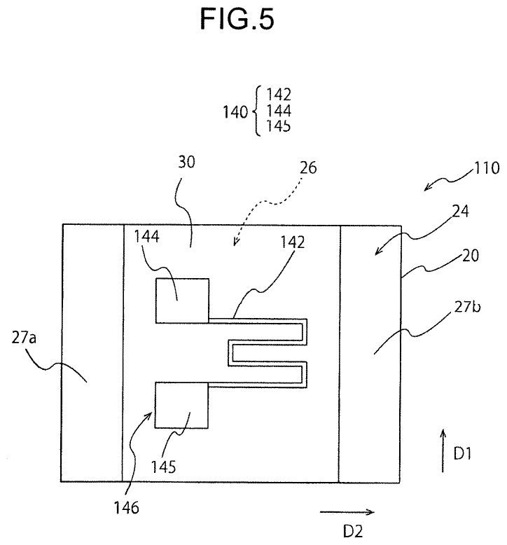

FIG. 5 is a plan view showing a sensor 110 according to the second embodiment. In the sensor 110, the orientation of a conductive layer pattern 140 with respect to the first direction D1 is different; however, rest of characteristics are the same as the sensor 10 shown in FIG. 1. The description of the sensor 110 is mainly focused on the difference between the sensor 10, and the common characteristics are omitted.

As shown in FIG. 5, the conductive layer pattern 140 of the sensor 110 has two electrode pads 144 and 145 and a resistive film 142 electrically connected to the two electrode pads 144 and 145, which are similar to the conductive layer pattern 40 of the sensor 10 shown in FIG. 1. The resistive film 142 of the conductive layer pattern 140 has a square wave form or a meander form, and the amplitude direction is different from that of the resistive film 42 shown in FIG. 1. Also, the two electrode pads 144 and 145 are aligned along the first direction D1 which is different from the sensor 10 in which the two electrode pads 44 and 45 are aligned along the second direction D2 (see FIG. 1). In the sensor 110, the conductive layer pattern 140 is provided between the two exposed areas 27a and 27b of the at least two exposed areas 27a and 27b (in the present embodiment, two exposed areas) in the amplitude direction of the square wave form and the meander form of the resistive film 142 in plan view.

As it can be understood by comparing the sensor 10 shown in FIG. 1 and the sensor 110 shown in FIG. 5, the shapes and the orientation of the conductive layer pattern 40/140 provided on the insulation film 30 formed on the surface 24 of the metal base 20 are not particularly limited, and it can be any shape which allows the detection of the deformation of the metal base 20 from its resistance change. As shown in FIG. 5, by arranging the conductive layer pattern 140 between the two exposed areas 27a and 27b in the amplitude direction of the meander form of the resistive film 142 in plan view, the direction connecting the fixing positions where the metal base 20 is fixed to the other member 70 (see FIG. 4) can be aligned to the direction of strain to be detected by contacting the two exposed areas 27a and 27b with the electrode of the resistance welding. Thereby, strain caused in the other member 70 can be efficiently transferred to the metal base 20, and a detection sensitivity of strain can be enhanced. In the sensor 110 shown in FIG. 5, the insulation film 30 covers the first area 26 which exists in the first direction D1 in plan view with respect to the conductive layer pattern forming area 146 to which the conductive layer pattern 140 is formed; thus, the insulation property can be appropriately secured between the conductive layer pattern 40 and the surface 24 of the metal base 20. Further, in regards with the common configurations as the sensor 10, the sensor 110 exhibits the same effects as the sensor 10.

### Third Embodiment

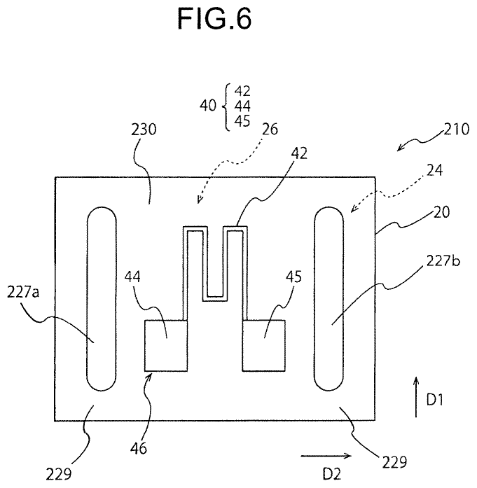

FIG. 6 is a plan view showing a sensor 210 according to the third embodiment. In the sensor 210, the shapes and the orientation of exposed areas 227a and 227b and a non-exposed area 229 are different compared to the sensor 10 shown in FIG. 1; and other configurations are basically the same as the sensor 10 shown in FIG. 1. The sensor 210 is described by focusing mainly on the different configurations compared to the sensor 10, and for the configurations which are the same as the sensor 10 are given the same numerical signs, and the descriptions of these are omitted.

As shown in FIG. 6, on the surface 24 of the metal base 20 of the sensor 210, two exposed areas 227a and 227b are arranged so that these sandwich the conductive layer pattern 40 from the both sides along the second direction D2 in plan view. However, the exposed areas 227a and 227b of the sensor 210 are not positioned at end parts of the metal base 20 in the second direction D2. As shown in FIG. 6, on the surface 24 of the metal base 20, the exposed areas 227a and 227b are surrounded by the non-exposed area 229 which is covered with an insulation film 230. That is, the exposed areas 227a and 227b of the sensor 210 are exposed from the insulation film 230 due to through holes formed on the insulation film 230.

As shown in FIG. 6, the shapes and the areas of the exposed areas 227a and 227b are not particularly limited, and the shapes and the areas can be determined based on the purpose of use. Furthermore, for the same configurations, the sensor 210 exhibits the same effects as the sensor 10.

### Fourth Embodiment

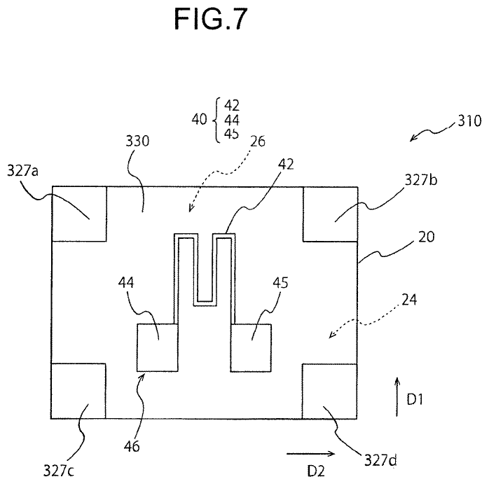

FIG. 7 is a plan view showing a sensor 310 according to the fourth embodiment. The sensor 310 has four exposed areas 327a, 327b, 327c, and 327d, which is different from the configuration of the sensor 10 shown in FIG. 1; and for other configurations the sensor 310 and the sensor 10 are the same. The sensor 310 is described by focusing mainly on the different configurations compared to the sensor 10, and the configurations which are the same as the sensor 10 are given the same numerical signs and the descriptions of these are omitted.

As shown in FIG. 7, the surface 24 of the metal base 20 of the sensor 310 is formed with the exposed areas 327a, 327b, 327c, and 327d exposing form an insulation film 330 at the four corners of the surface 24 of a rectangular shape. Each shape of the exposed areas 327a, 327b, 327c, and 327d are approximately a square shape.

As shown in FIG. 7, the number and the arrangement of the exposed areas 327a, 327b, 327c, and 327d are not particularly limited, and the surface 24 may have three or four or more of the exposed areas 327a, 327b, 327c, and 327d. Further, for the same configurations, the sensor 310 exhibits the same effects as the sensor 10.

Hereinabove, the sensor according to the present disclosure was described using the several embodiments, however, the technical scope of the sensor according to the present disclosure is not limited to the above-mentioned embodiments, and the sensor according to the present disclosure includes other embodiments and modified examples. For example, the number of the conductive layer pattern 40/140 formed on the surface 24 of the metal base 20 is not limited to one, and two or more conductive layer patterns 40/140 may be provided on the insulation film formed on the surface 24 of the metal base 20. Also, in the case that a plurality of conductive layer patterns 40/140 are formed, each of the conductive layer patterns 40/140 may be electrically independent, or it may be electrically connected by forming a bridge circuit, etc.

As is understood from the above description, the present specification discloses the following.
[1]

A sensor, including:
a metal base having a surface formed with streaks along a first direction in plan view, and a conductive layer pattern provided on an insulation film formed on the surface;
wherein, on the surface, the insulation film covers a first area which exists towards a first direction in plan view with respect to a conductive layer pattern forming area formed with the conductive layer pattern, and
the surface includes an exposed area exposed from the insulation film at a position different from the first area in plan view.
[2]

The sensor according to [1], wherein the surface includes at least two exposed areas, and the conductive layer pattern exists between the at least two exposed areas in plan view.
[3]

The sensor according to [2], wherein the conductive layer pattern has a patterned portion shaped in a square wave form or a meander form in plan view, and
the conductive layer pattern is provided between two exposed areas among the at least two exposed areas in an amplitude direction of the square wave form or the meander form.
[4]

The sensor according to any one of [1] to [3], wherein a surface roughness Ra of the surface in regards with a second direction which is perpendicular to the first direction in plan view is 0.05 μm or larger and 1 μm or smaller.

### REFERENCE SIGNS LISTS

10, 110, 210, 310,810 . . . Sensor
20 . . . Metal base
22 . . . Rear surface
24 . . . Surface
25 . . . Streaks
26 . . . First area
27a, 27b, 227a, 227b, 327a, 327b, 327c, 327d . . . Exposed area
27b . . . Exposed area
28 . . . Conductive layer pattern forming area
29, 229 . . . Non-exposed area
30, 230, 330, 830 . . . Insulation film
40, 140 . . . Conductive layer pattern
42, 142 . . . Resistive film
44, 45, 144, 145 . . . Electrode pad
46, 146 . . . Conductive layer pattern forming area
70 . . . Other member
71 . . . Electrode
D1 . . . First direction
D2 . . . Second direction
826 . . . First direction exposed area
51, 52 . . . Etching residue

What is claimed is:

1. A sensor, comprising:
a metal base having a surface formed with streaks along a first direction in plan view, and a conductive layer pattern provided on an insulation film formed on the surface;
wherein, on the surface, the insulation film covers a first area which exists towards a first direction in plan view with respect to a conductive layer pattern forming area formed with the conductive layer pattern, and
the surface comprises an exposed area exposed from the insulation film at a position different from the first area in plan view.

2. The sensor according to claim 1, wherein the surface comprises at least two exposed areas, and the conductive layer pattern exists between the at least two exposed areas in plan view.

3. The sensor according to claim 2, wherein the conductive layer pattern has a patterned portion shaped in a square wave form or a meander form in plan view, and
the conductive layer pattern is provided between two exposed areas among the at least two exposed areas in an amplitude direction of the square wave form or the meander form.

4. The sensor according to claim 1, wherein a surface roughness Ra of the surface in regards with a second direction which is perpendicular to the first direction in plan view is 0.05 μm or larger and 1 μm or smaller.
